(19) United States
(12) Patent Application Publication
(10) Pub. No.: US 2009/0279963 A1
(43) Pub. Date: Nov. 12, 2009

(54) Adjustable-cutting edge drilling-reaming tool

(76) Inventor: Ermanno D'Andrea, Piazza Unita D'italia (IT)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 11/973,005

(22) Filed: Oct. 4, 2007

(30) Foreign Application Priority Data
Apr. 10, 2006 (IT) MI2006A-001909

(51) Int. Cl. B23C 5/24

(52) U.S. Cl. 407/45; 407/47; 407/46

(57) ABSTRACT

A drilling and reaming tool, having a tool body and radially opposite adjustable cutting edges, comprises a first supporting element for a cutting edge to be adjusted by a presetting method, a second supporting element for a cutting plate, being coupled to a movable slide, in turn coupled to a column element projecting inside the tool body, the column element being traversed by a threaded pin, having an enlarged portion enclosed by precision bearing, a stem having an end portion extending toward the circumference of the tool body being coupled to a disc including a graduated scale cooperating with a vernier element arranged on the tool body, the disc including a polygonal opening for engaging therein an adjusting tool.

### BACKGROUND OF THE INVENTION

The present invention relates to an adjustable-cutting edge drilling-reaming tool.

Tools for drilling and reaming workpieces are already known in the prior art. The prior tools comprise contoured supporting tool bodies and being coupled, by adapters or extensions to a driven spindle of a machine tool.

Such a prior tool comprises two supporting elements having corresponding cutting plates for removing chips as the tool is rotatively driven.

The cutting plates are arranged with a diametrically opposite relationship, and one thereof is used for performing a roughing operation on the hole being formed, whereas the second cutting plate is used for performing a finishing operation of the hole, with a reduced material removal.

Said prior tools, accordingly, receive the supporting elements for the machining plates, which can be radially displaced and adjusted by means of screw mechanisms, arranged inside the tool body.

For precisely locating the two plates, depending on the size of the hole to be made, for each cutting plate supporting element a vernier or nonious system allowing to perform an accurate adjustment of the corresponding cutting plate is used.

Thus, the provision of two separated units to adjust the cutting plate performing for the roughing machining operation and to also adjust, with a very high accuracy, the cutting plate performing the finishing operation, requires a comparatively high labor and cost.

Moreover, to the foregoing it is be added that, whereas the roughing tolerances are very broad, and do not require an expensive micrometric adjustment of the corresponding plate, the adjustment of the fine machining cutting plate, necessarily requires a micrometrically accurate cutting edge fitting.

### SUMMARY OF THE INVENTION

Accordingly, the aim of the present invention is to simplify the construction of a combined roughing and finishing tool, having two adjustable cutting plates, to allow the roughing cutting plate to be quickly adjusted by a presetting operation, while allowing the finishing plate to be also quickly micrometrically directly adjusted in the machine tool itself.

The above object is achieved by a drilling and reaming tool, having radially opposite adjustable cutting edges, a first cutting edge supporting element which can be adjusted by a presetting adjusting method, a second cutting plate supporting element coupled to a movable slide, in turn coupled to a column element projecting from an inner space of the tool body, said column element being traversed by a threaded stem, having an enlarged portion arranged between precision bearings, said stem having an end portion extending toward a circumference of the tool body and coupled to a disc including a graduated scale cooperating with a vernier element arranged on the tool body, said disc having a contoured polygonal opening for engaging an adjusting tool therein.

Further characteristics and advantages of the invention will become more apparent from the following disclosure and accompanying dependent claims.

### BRIEF DESCRIPTION OF THE DRAWINGS

The subject matter according to the invention will be disclosed and illustrated in a more detailed manner hereinafter, with reference to an exemplary embodiment thereof, which is shown in the accompanying drawings, where:

FIG. 1 is a front view of the tool;

FIG. 2 is a view of the tool taken according to the arrow (f) of FIG. 1;

FIG. 3 is a partially cross-sectioned view of the tool shown in FIG. 2;

FIG. 4 is a further cross-sectional view, taken along the line IV-IV of FIG. 2, of the tool shown in FIG. 2; and

FIG. 5 is a bottom view of the tool.

### DESCRIPTION OF THE PREFERRED EMBODIMENTS

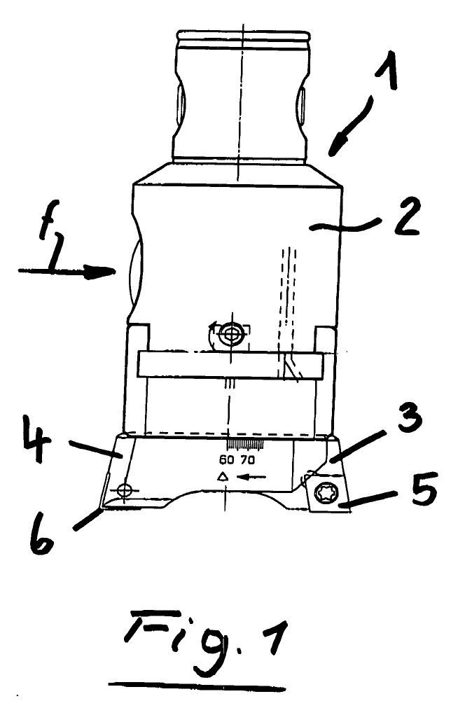

As shown in FIG. 1, the tool, which has been generally indicated by 1, comprises a substantially cylindrical tool body 2 housing, at the bottom thereof, per se known radially movable supporting elements 3 and 4, comprising corresponding cutting plates 5 and 6.

Said supporting elements 3 and 4 can be radially driven, to adjust, in a desired and accurate manner, the cutting edges 5 and 6 of the cutting plates, depending on the size of the hole to be made.

The cutting edge 6 is advantageously used for performing a roughing operation, whereas the cutting edge 5 is used for performing a finishing operation.

In this connection it should be apparent that the functions of the cutting edges 5 and 6 could also be freely reversed.

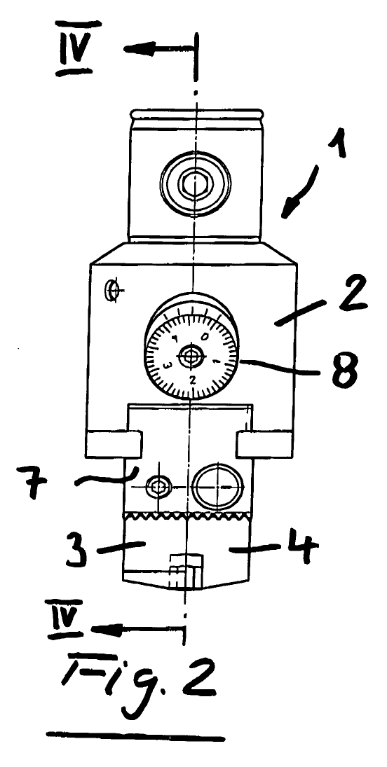

FIG. 2 is a view substantially taken in the direction of the arrow (f) of FIG. 1, showing the subject tool 1.

It is possible to note therein the two support elements 3 and 4, provided for receiving the cutting plates (not shown in FIG. 2).

The support elements 3 and 4 comprise an indentation arrangement, by which said supporting elements 3 and 4 are coupled to a corresponding indentation arrangement of a slide 7, which is movably supported by the tool body 2.

The tool body 2 comprises a vernier or nonious system 8 which will be disclosed in more detailed manner hereinafter.

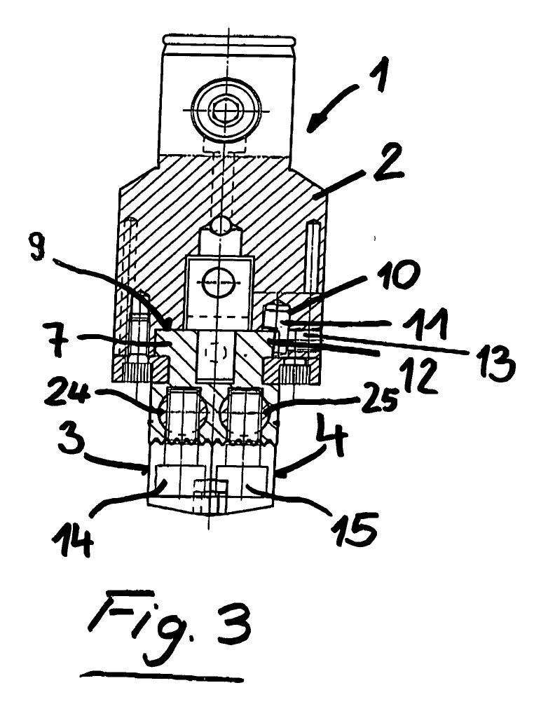

FIG. 3 shows the tool 1 of FIG. 2, and a portion of the tool body 2 and the supporting elements 3 and 4, which are herein shown respectively partially cross-sectioned.

FIG. 3 clearly shows that the slide 7 is supported, inside the tool body 2, by suitable precision prismatic guides, indicated by the reference number 9.

Said tool body 2 comprises, on a side thereof, a blind hole 10, in which is engaged a pin or screw 11 having a step 12 which, by a further screw (not shown) threaded in the hole 13 can be forcibly pressed against the slide 7.

The cutting plate supporting elements 3 and 4 are coupled to said slide 7 by coupling screws 14 and 15.

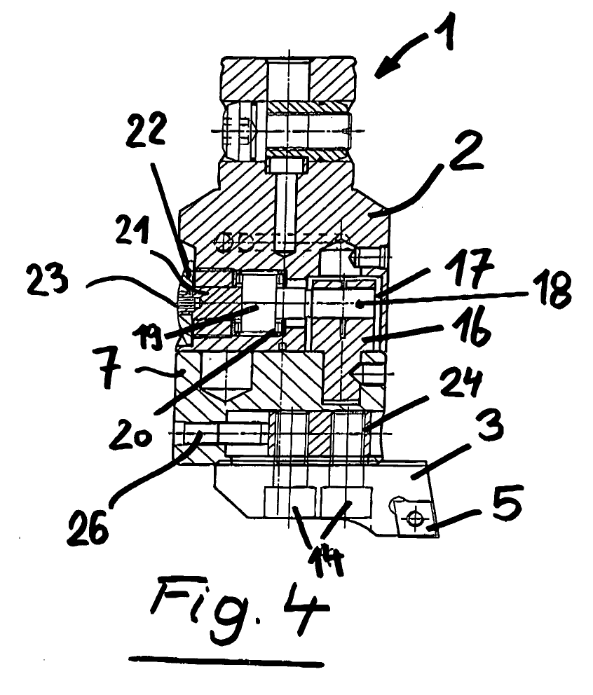

FIG. 4 is a cross-sectional view, taken along the line IV-IV of FIG. 2, showing the tool 1 and tool body 2.

In particular, the cutting plate 5 supporting element 3 is locked, by locking screws 15, against the slide 7.

Thus, said supporting elements 3 and 4 are locked on the slide 7 by the locking screws 14 and 15 and by slidable pins 24 and 25 which can be adjusted by corresponding adjusting screws 26 and 27.

The presetting adjustment of the supporting elements 3 and 4 is performed by slightly screwing off the screws 14 and 15, and then displacing the sliding pins 24 and 25 by operating the screws 26 and 27 and then locking again the screws 14 and 15.

To the slide 7 is coupled, advantageously by a geometrical type of coupling, a column element 16, which is arranged, with a radial clearance, in a chamber 17 formed in the tool body 2. Said column element 16 is traversed by a threaded stem 18, including an enlarged portion 19 supported by precision bearing 20, said stem 18 extending through an extension 21 toward a disc 22 forming a portion of a vernier or nonious system 8, shown, by a front view, in FIG. 2.

FIG. 4 clearly shows that the precision adjusting means for precisely adjusting the cutting plate 5 supported on the supporting element 3, have a very simple construction, including a slide 7, a driving column element 16, a threaded shaft 18 supported, through an enlarged portion, by rolling bearings 20 to be coupled, through a coupling extension 21, to the disc 22 of the vernier adjusting system 8.

To perform a quick fine adjustment of the cutting plate 5, the disc 22 comprises a polygonal recess 23, therein a torsion wrench (not shown) can be engaged.

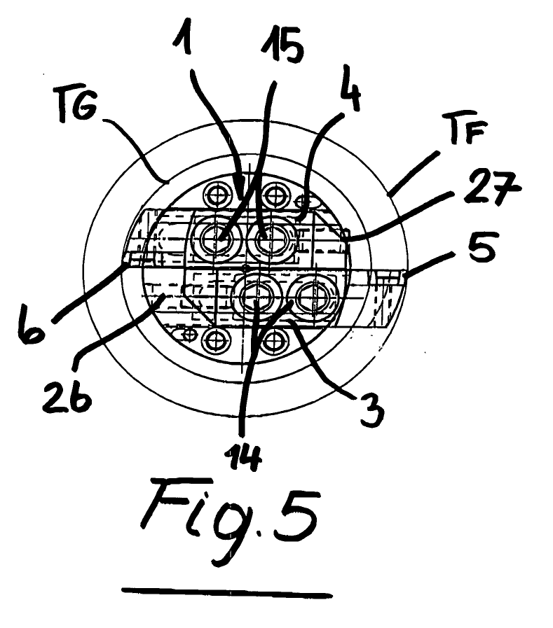

FIG. 5, which is a bottom view of the tool 1, clearly shows the supporting elements 3 and 4 supporting the cutting plates 5 and 6. It shows moreover the screws 14 for assembling the supporting element 3 on the radially movable slide.

As is further herein shown, the tool 6, which is driven along the cutting circle TG allows to perform roughing operations, whereas the cutting plate 5, driven along a cutting circle TF allows to perform on the workpiece finishing operations.

The cutting circles TG and TF have been shown in FIG. 5 merely by way of an example and, obviously, depending on the materials to be machined and on the used cutting plates, the radii of said circles TG and TF can be changed as desired.

1. A drilling and reaming tool (1) having a tool body (2) and radially opposite adjustable cutting edges, characterized in that said tool comprises a first supporting element (4) for a cutting edge (6), which can be adjusted by a presetting adjusting method, a second supporting element (3) for a cutting plate (5) being coupled to a radially movable slide (7) coupled to a column element (16) projecting in an inner space (17) of said body (2) of said tool (1), that said column element (16) is traversed by a threaded stem (18) having an enlarged portion (19) arranged between precision bearings (20), that said stem (18) has an end portion thereof extending toward a circumference of said tool (1) body (2) and coupled to a disc (22) including a graduate scale cooperating with a vernier element (8) arranged on said tool (1) body (2), and that said disc (22) comprises a polygonal opening (23) for engaging therein and adjusting tool.

2. A drilling and reaming tool, according to claim 1, characterized in that said supporting elements (3, 4) comprise an indentation arrangement engaging with a corresponding indentation arrangement formed in said slide (7).

3. A drilling and reaming tool, according to claim 1, characterized in that said slide (7) is supported in said tool (1) body (2) by supporting precision prismatic guides (9).

4. A drilling and reaming tool, according to claim 1, characterized in that said tool (1) body (2) comprises an inner blind hole (10) therein a pin (11) having a step (12) is engaged, and that said step (12) can be forcibly pressed, through a threaded pin threadably engaged in a hole (13), against said slide (7).

5. A drilling and reaming tool, according to claim 1, characterized in that said supporting elements (3, 4) are locked on said slide (7) by locking screws (14, 15) and slidable pins (24 and 25) which can be adjusted by adjusting screws (26 and 27), and that said supporting elements (3 and 4) are presettably adjusted by screwing-off said screws (14 and 15) to cause said sliding pins (24 and 25) to be displaced by said screws (26 and 27).
